(19) United States
(12) Patent Application Publication
(10) Pub. No.: US 2006/0116904 A1
(43) Pub. Date: Jun. 1, 2006

(54) Wound electronic medical record system

(76) Inventor: Harold Brem, Bronx, NY (US)

Correspondence Address: HOLLAND & KNIGHT LLP, 2099 PENNSYLVANIA AVE, N.W., WASHINGTON, DC, 20006, US

(21) Appl. No.: 11/241,800

(22) Filed: Sep. 30, 2005

Related U.S. Application Data
(60) Provisional application No. 60/614,548, filed on Oct. 1, 2004.

(51) Int. Cl. G06Q 10/00

(52) U.S. Cl. 705/2

(57) ABSTRACT

Methods and apparatus for storing and reviewing wound data are shown using a digital datasheet, or wound electronic medical record (WEMR). The WEMR is preferably presented via a single page containing all data that should be considered by a wound healing provider, as predetermined by protocol. This includes, but is not limited to, fields for: a digital photograph of the wound; a graph of the wound healing rate (length, width, depth and area over time); wound and other treatments including current systemic medications, along with a patient identifier and review/approval indicator. This may also include hematology and chemistry laboratory data; radiology and pathology images along with their associated reports; ambulation status and other history; and microbiology data including sensitivities. The WEMR is implemented via a wound database system, which includes templates and policies for rapid report generation and tools for protocol mapping. A particular WEMR page may be designed for electronic or paper review and approval by a treating physician, thus permitting comprehensive but efficient review of all relevant wound data, whether for a personal or remote consult, real-time or otherwise. When teaching or doing studies, patient identifier information can be masked while still enabling review of large but detailed data sets for a variety of wound and patient criteria.

### FIELD OF THE INVENTION

The invention in general relates to the field of medical treatment and record systems, and more particularly to systems for managing wound patient treatments and related records.

### BACKGROUND

More than 3 million patients suffer from pressure ulcers each year. By the year 2025 it is estimated that 300 million persons in the world will have diabetes, and today over 15% of the patients with diabetes report having had a prior foot ulcer. While most foot ulcers heal, every year, over 80,000 patients with non-traumatic diabetic foot ulcers undergo amputations, and peri-operative mortality rates associated with such amputations approach 6%. These statistics are all the more startling when one recognizes that specific protocols for effectively treating both types of ulcers exist and are well-established in the literature. If these protocols exist, why do these statistics remain so high?

A primary reason is that the current standards of data collection and dissemination are inadequate. Even in cases where treatments and medical information are documented repeatedly by multiple wound care providers, this information is regularly stored in different places and is often, as a practical matter, inaccessible to all care providers. In other cases, important data is not collected and documented. Either way, treatment decisions are made based on only part of the information that should be used, leading to costly delays in implementing corrective strategies. Most amputations can be avoided by early detection and appropriate treatment.

The same is true in a variety of other wound healing treatments. Whether considering internal wounds like venous stasis, surface conditions like scars and cellulitis, skin grafts and surgical wounds, or complications from conditions like lymphedema, osteomyelitis or HIV, the complexity and multi-disciplinary nature of wound treatment makes prior approaches dependent on paper and simple electronic record keeping inadequate. Important information is not gathered, and the cumbersome way in which collected information is stored and accessed means significant data is overlooked.

A further problem arises because of the variety of diagnostic tools and treatment options that may be available for specific types of wounds. In many cases, evidence-based protocols for the treatment of some wounds have yet to be established. Even for those that have been proposed, treatment protocols should not be viewed as static, but paper—(or memory-) based protocols do not lend themselves to rapid empirical review and modification, including more focused or individualized treatments.

While many millions of dollars have been spent on exploring different approaches at automating the information collection and accessibility of medical records, these largely remain cumbersome and incomplete systems for purposes of wound treatment. For example, in U.S. Pat. No. 6,143,212, one approach to automating the wound measurement process is shown. Once captured, several different ways to present it graphically are shown, along with various input screens for information relating to the patient and wound. However, this is an expensive approach for measuring most wounds, does not capture enough information for most wound treatment protocols, and is far from simple in terms of navigating through the various screens to view what information has been captured.

Another approach to automated medical records can be seen in U.S. Patent Application 2003/0083903. This application discloses an automated method (among other things) for prompting physicians to enter through a series of input screens all the information required by established billing (and hence protocol) processes for patient treatment, all contemporaneous to a treatment session. Yet another approach is seen in U.S. Pat. No. 5,581,460, which discloses means for automating medical report generation by combining patient, clinical and examination, and image data in a diagnostic report. While useful for simple diagnostic record keeping, it does not address how one might capture and coordinate more complex data sets and present them in a form that can be used as a basis for treatment decisions by a variety of care providers.

One of the keys to reducing the incidence of chronic wounds (particularly pressure ulcers and diabetic foot ulcers) is early detection and comprehensive therapy. The information critical to wound healing should be easily disseminated among health care practitioners, coordinated via an easily understandable form, and readily-accessible. No prior wound treatment system provides a consolidation of wound data into a single form. To achieve this, what is needed is an integrated process for implementing evidence-based protocols, including data capture and reporting, that still offers ease of use for the inputting and reviewing practitioners. An information system that harnesses the capabilities of existing computer, storage, digital, and communications technologies, providing clinicians with timely and accurate access to pertinent patient information, while also providing a tool to objectively monitor the patient's wound healing progress, would significantly accelerate healing and reduce wound morbidity amputation rates. The present invention provides just such advantages, among others.

### SUMMARY

An illustrative summary of the invention, with particular reference to the exemplary embodiment described below, includes a method and apparatus for storing and reviewing wound data using a digital datasheet, or wound electronic medical record (hereinafter “WEMR”). The WEMR is preferably presented via a single page containing all data that should be considered by a wound healing provider, as predetermined by protocol. This includes, but is not limited to, fields for: a digital photograph of the wound; a graph of the wound healing rate (length, width, depth and area over time); wound and other treatments including current systemic medications, along with a patient identifier and review/approval indicator. This may also include, but is not limited to, hematology and chemistry laboratory data; radiology and pathology images along with their associated reports; ambulation status and other history, and microbiology data, including sensitivities. This WEMR is implemented via a wound database system, which includes templates and policies for rapid report generation and tools for protocol mapping. A particular WEMR page may be designed for electronic or paper review and approval by a treating physician, thus permitting comprehensive but efficient review of all relevant wound data, whether for a personal or remote consult, real-time or otherwise. It may also be accomplished in a Health Insurance Portability and Accountability Act (HIPAA) compliant manner, assuring patient confidentiality. When teaching or doing studies, patient identifier information can be masked while still enabling review of large but detailed data sets for a variety of wound and patient criteria.

A WEMR also makes possible more robust, evidence-based protocols for wound treatment, including complex regimes implemented by multiple care providers. One such protocol includes: 1) regular examination of skin (e.g., daily, for feet, pelvis, sacrum); 2) initiation of a treatment protocol when a wound is recognized; 3) regular objective measurements (e.g., weekly photography and planimetry); 4) establishing a proper healing environment (e.g., moist bed, pressure relief); 5) elimination of drainage and cellulitis and, where indicated, histology-guided debridement; 6) consideration of biological treatments (e.g., growth factor, cellular therapies); 7) nutritional supplementation, physical therapy, pain elimination or a combination thereof. The WEMR enables streamlined collection of and access to all the relevant wound data for each treatment. It also enables an empirical validation of a protocol, permitting improved studies and more rapid improvements as new tools and therapies are developed.

A variety of benefits flow from use of a WEMR-based system. For example, hospitals stand to benefit from improved care and reduced costs, via efficient allocation of physician time (allowing specialized wound physicians to treat more patients and other doctors to be better focused on patients in their respective specialties), lower administrative costs (allowing all the paperwork to be completed in as little as 5 minutes or less by a technician, so doctors and nurses can spend more time with their patients), decreased length of stay, and simplified billing. Government agencies can benefit by reduced wound reimbursement (e.g., via Medicare/Medicaid programs), and reduced para-transit subsidies (approximately 3.4 million people depend on Medicaid funded transportation to get to care providers in the U.S. at a cost of over US$1 billion). Patients enjoy more efficient and higher quality care, due to the factors such as specialized treatment from wound specialists (rather than relying on doctors of other backgrounds in the poly consultative model), earlier identification of wounds and treatments (also empowering more efficient and remote/convenient treatments), and less dislocation.

### BRIEF DESCRIPTION OF THE DRAWINGS

The preferred embodiments of the invention may be more readily appreciated from the following detailed description, when read in conjunction with the accompanying drawings, in which:

FIG. 1 is a block diagram illustrating a wound treatment information system in accordance with an exemplary embodiment of the invention;

FIG. 2 is a flow chart of wound data input and review processes in accordance with an exemplary embodiment of the invention;

FIGS. 3-13 are illustrative of various data input screens that can be used in implementing the process of FIG. 2, in which:

FIG. 3 shows an entry “switchboard” screen;

FIG. 4 shows a first data menu screen;

FIG. 5 shows a patient data entry screen;

FIG. 6 shows a primary wound data entry screen;

FIG. 7 shows a wound location screen;

FIG. 8 shows a debridement/biological treatment screen;

FIG. 9 shows an antibiotics/medication screen;

FIG. 10 shows a wound culture screen;

FIG. 11 shows a radiology screen;

FIG. 12 shows a pathology screen;

FIG. 13 shows a chemistry/hematology screen;

FIG. 14 is illustrative of data categories presented via a WEMR report page;

FIG. 15 is illustrative of a WEMR report page (for a foot ulcer report);

FIG. 16 is a flow chart of image capture and insertion;

FIG. 17 is a flow chart of a protocol and report template design process;

FIG. 18 is illustrative of an exemplary (pressure ulcer) protocol template;

FIG. 19 is illustrative of another exemplary (diabetic foot ulcer) protocol template;

FIG. 20 is illustrative of a manually designed WEMR report page (in database design view);

FIG. 21 is illustrative of another exemplary embodiment of a WEMR report page, for an abdominal surgical wound report;

FIG. 22 is illustrative of another exemplary embodiment of a WEMR report page, for a pressure ulcer report.

### DETAILED DESCRIPTION OF THE PREFERRED EMBODIMENTS

One embodiment includes a method and apparatus for wound management coordinated via use of a wound electronic medical record (WEMR). In the exemplary embodiment discussed below, a WEMR chart is presented to care providers via an integrated page of current wound data for each wound of a patient using protocol-determined fields. It may be implemented in both local and remote modes, using standardized or tailored formats convenient for a care provider. Since all wound information is collected in a wound database, individualized presentations can be readily made for different categories of wounds and for different care providers. The robust data collection facilitates early detection of problems and rapid intervention. The data sets collected enable intelligent, evidence-based protocol development and evolution, including establishment of standard rates of healing (e.g., for pressure ulcers) and time to closure (e.g., for diabetic foot ulcers). The WEMR system also enables a variety of learning and consultation applications that to date have been too complex to implement. All these combine to yield better wound care for a patient, better information flow for wound care providers, more efficient use of scarce physician time, and significant cost savings for everyone.

1. System Overview

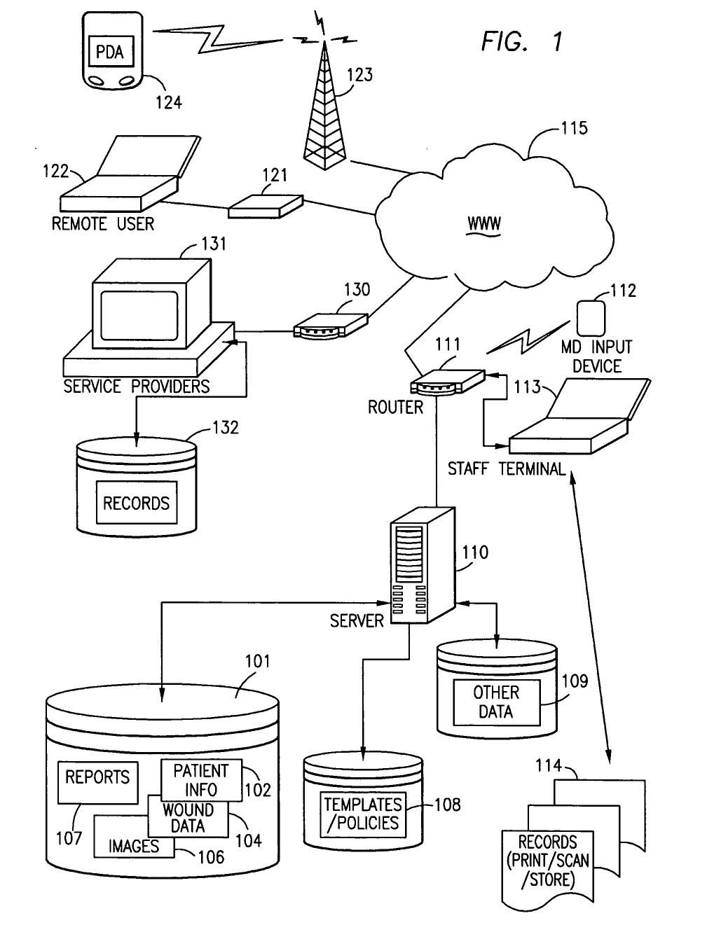

Referring to FIG. 1, an overview is presented of some of the components that can make up a WEMR system in one embodiment of the invention. At the core of the WEMR system is one or more WEMR databases 101, which store the wound data and other records that support an integrated WEMR. This data is stored in one or more record tables, such as the illustrated patient info, wound data, image and reports tables 102-107. The data may all be stored locally in wound database 101, or stored in other databases 109, 132. All data may be relationally coupled to the WEMR and wound database 101, or coupled via object or other database technologies. Thus, the structure is flexible enough to accommodate generic as well as unusual data architectures. In one embodiment the key wound data viewed as part of the electronic chart by care providers is all stored in a common database 101. A WEMR DBMS (data base management system) program on server 110 is provided to control the set up and information flow between the various data stores 101, 109 and 132, and user devices 112, 113, 122 and 124. In addition, design templates, data rules and policies, and other administrative tools 108 are available to help implement robust protocols and data workflow to care providers, payors, and other interested parties (not shown).

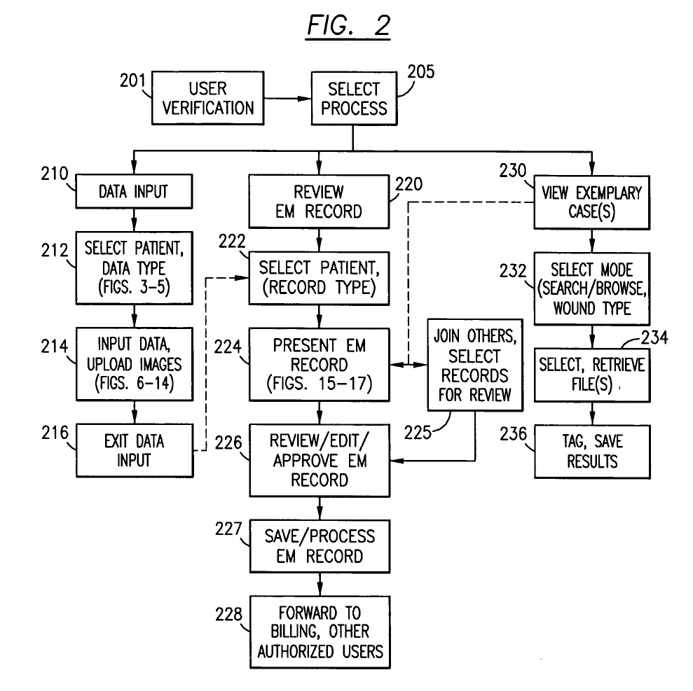

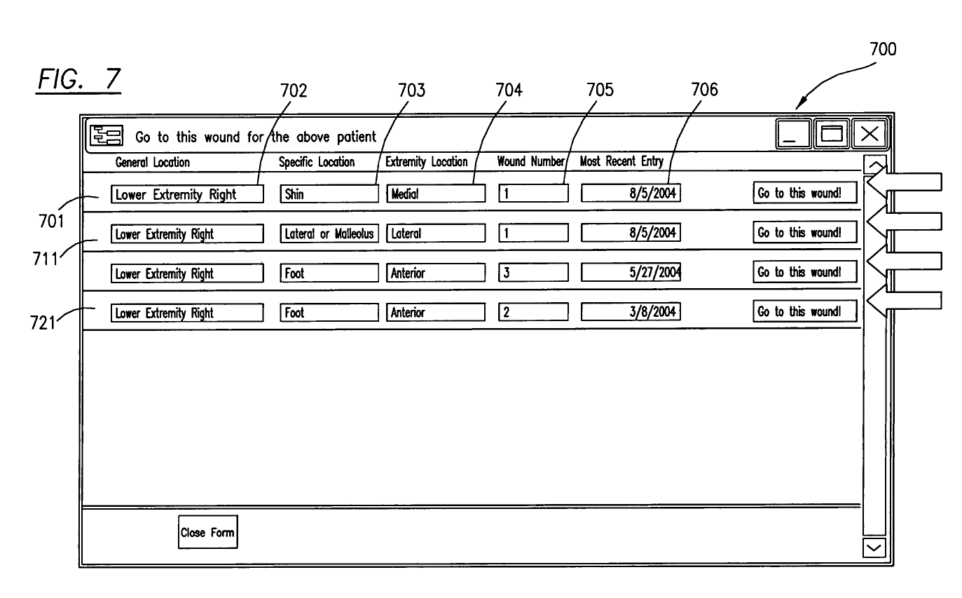

In typical use, a care provider at a clinic, hospital or lab performs all indicated tests and observations for a patient under wound management, and the observed results are input for storage in a medical database 101 or 109. If desired, parts of the observation and input process may be automated. These approaches may run from the more complex tools, such as is seen by the automated wound measurement process of U.S. Pat. No. 6,143,212, or simpler ones like the WoundImager™ software from Med-Data Systems of Cherry Hill, N.J., which provides automated measurements based on digital images. The Images may be captured via inexpensive digital cameras and uploaded to image databases 106 with just minor changes provided by off the shelf software (e.g., Adobe's Photoshop). More specialized systems may also be used in automating portions of the capture, manipulation and storage of image data. Data that has already been captured in other databases 109 can be automatically linked, or retrieved by automated push or pull techniques (e.g., rules, agents, etc.). For example, chemistry, hematology, microbiology and stat lab data is already shared in intra-hospital systems using applications by SCC Labs, sent in HL7 language. Interface engines in turn can direct the data to the several different computer systems, and when received, server 110 can automatically store the pertinent data in the correct record. New data inputs can also be directly input using the process described below in connection with FIGS. 2-13.

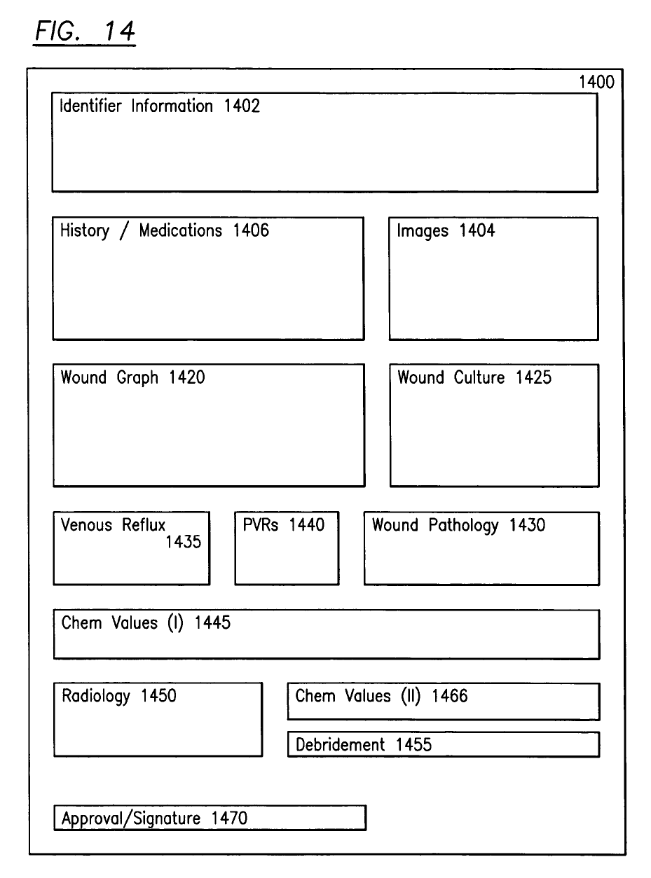

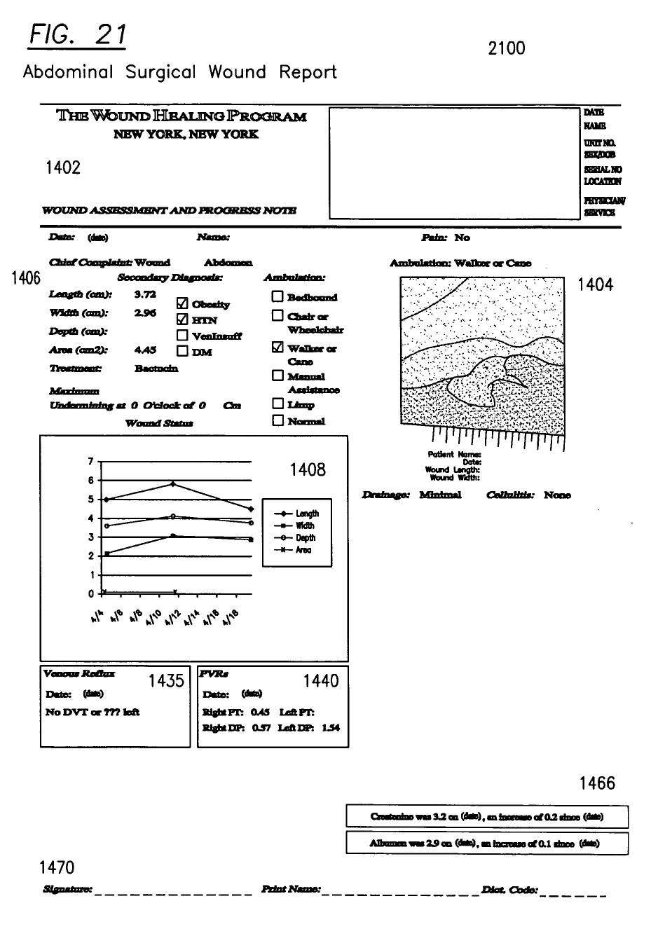

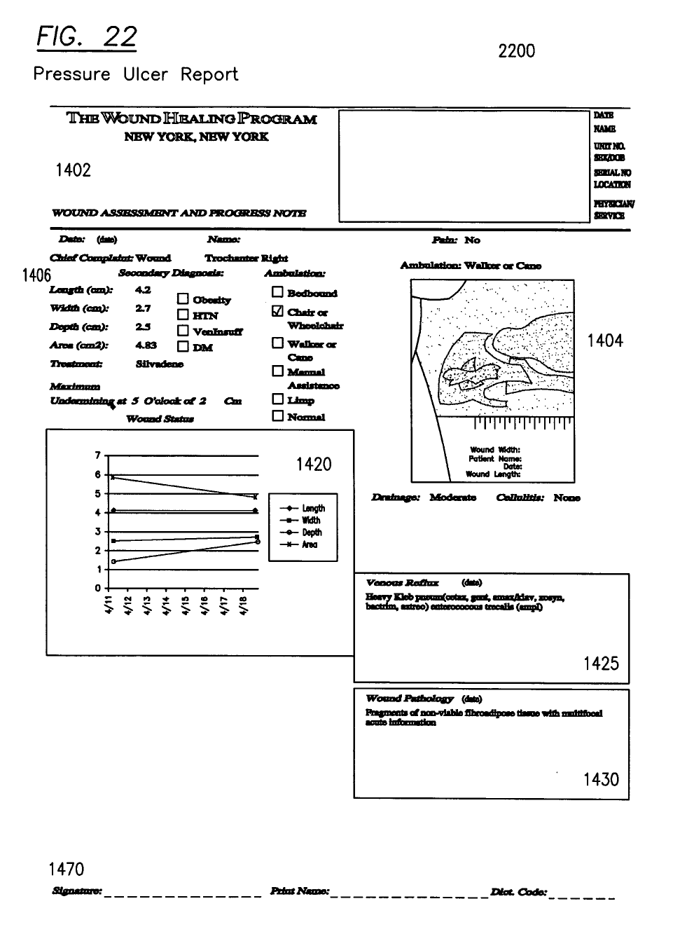

Once input into the WEMR, all data is accessible to authorized care providers. In the exemplary embodiment discussed below, the electronic chart of the WEMR is presented as a single page of all the data pertinent to that care provider's assessment and treatment of a wound patient. The pages illustrated in connection with FIGS. 14-15 and 21-22 show examples of effective reports. These digital datasheets contain all the pertinent data needed for an effective wound assessment, including, but not limited to: digital photograph(s) of the wound; an up-to-date graph of the wound showing healing rate (e.g., length, width, depth and area over time); hematology and chemistry laboratory data; radiology and pathology images along with their associated reports; wound and other treatments, including current systemic medications; and microbiology data including sensitivities. As an intervention tool, the WEMR includes necessary wound and medical information for each patient, and no matter how complex the clinical situation, presents it in a single form in a clear, comprehensive, and readily understood manner. This in turn allows the wound healing practitioner to view the necessary medical information efficiently and in real-time. The clinician now has access to updated information when evaluating the patient in one view, rather than in several locations scattered across multiple pages.

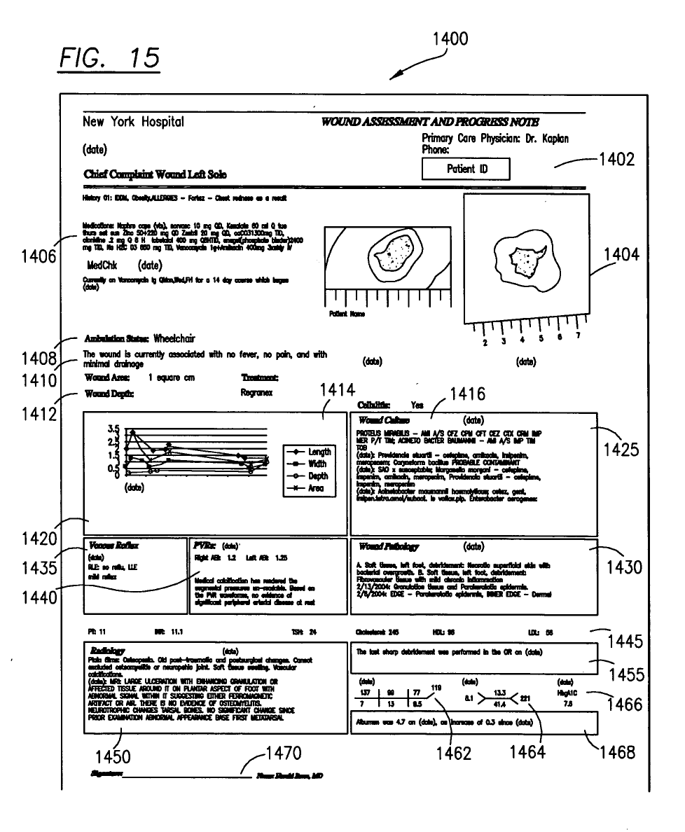

The WEMR electronic chart is also flexible. Since it may be protocol driven, different presentations can be provided based upon the type of wound involved, since only a subset of wound information may be required for management of certain wound types (compare, e.g., the different views of FIGS. 15, 21 and 22). Thus, pressure ulcers and diabetic foot ulcers can differ in their report datasheet layout because the data needed to treat these very different wounds is not the same. In the case of a diabetic foot ulcer, these windows accommodate an additional field for Pulse Volume Recordings (PVRs), the waveforms that are measurements of arterial inflow (see 1440 of FIG. 15); these measurements are not typically needed for pressure ulcers. Variations in reports are also possible based upon the role of the treating care provider. For example, group or role-based IDs (identifiers) can be used and associated with specialists such that data unnecessary for their review can be filtered from initial presentation. In the case of multiple wounds, charts for wounds that a particular specialist is not treating can be eliminated from view. This helps focus and streamline their review process, while still permitting the care provider to unfilter and access all available data to which she is authorized access if desirable for review. On the other hand, a WEMR can also be used to insure a uniformity of the information reviewed, enforcing a shared accountability of all care providers for acting on the most current wound data. The WEMR charts can be viewed and signed electronically, making it transparent to distance and hardware platform considerations. It can be served over local area networks to computers, wireless devices, small network appliances, or served via the internet 115 or other wide area connections to any variety of wired or wireless device 121-131, for which the device and/or user has sufficient privileges. This is accomplished in a HIPAA compliant manner, assuring patient confidentiality. Thus, the WEMR allows for data portability into any clinic. It also provides instant organized access to patient history information, such as allergies and past treatments, assisting in prescribing and the ordering of laboratory testing. If required by a local facility or convenient for a given practitioner, current charts can be output, signed and processed as a physical document 114.

By making wound data readily accessible to all care providers, the WEMR can become an integral element in effective wound management protocols. With regular photographing and measurement, non-contracting wounds are easily recognized, and possible complications like infection of soft tissue and osteomyelitis can be detected before consequences become dire. This is particularly important in the case of diabetic foot ulcers, where obvious signs of infection are often elusive.

Because the WEMR provides data in a manner displaying the most up to date data, it is less likely that any of this data will go unnoticed. While a subtle increase in wound area may be indiscernible to the eye, it would be obvious to anyone using the WEMR, since the wound area graph clearly indicates any slight increase. Old and new cultures related to the wound are posted on the WEMR, making the wound's relationship to other clinical events much easier to see. Similarly, when white blood cell count is elevated, the number can be highlighted, and its trend up or down is instantly available. These approaches give the clinician powerful tools in considering treatment options, making the WEMR a valuable diagnostic tool for detecting early responses to treatment.

The WEMR also facilitates the operation of integrated wound centers. Information sharing is one of the biggest problems in implementing standardized protocols. While most wounds are treated by a single doctor, the complex nature of wound healing, particularly at wound centers, calls for the collaboration of specialists dedicated to each ailment. For example, a single patient with a diabetic foot ulcer undergoing debridement for osteomyelitis routinely requires attention from as many as 12 healthcare professionals, including wound care nurses, an orthopedic surgeon, a vascular surgeon, a vascular medicine physician, a pathologist, a primary care physician, a radiologist, a wound care specialist, a physical therapist, a diabetologist, an infectious disease specialist, and a nutritionist. All these clinicians are mandated to document their inputs, including redundant aspects like the patient's history. While these wound centers represent the future of wound care, integrating all the data to permit efficiently integrated care for complicated wounds is a major challenge. The WEMR is key to providing just such an information backbone to leverage the full promise of integrated wound centers. More modest practices will similarly benefit by having access to the resources and learning (e.g., improved evidence-based protocols) of the major wound centers, in addition to the underlying efficiencies provided by the WEMR system for managing wound patients.

In addition to the information management issues associated with existing standards of care for complex chronic wounds, documentation in the patient record is a persistent problem. Despite many well-established protocols and guidelines for treating wounds like diabetic foot and pressure ulcers, one difficulty in implementing these protocols is the shared accountability for the condition of the wound. If data is missing, it is evident to all if reviewing an electronic chart; these items can be highlighted, or even subject to alerts, but in the end the increased data alone makes lapses apparent (e.g., a pre-albumen that continues to decrease, indicating inadequate nutritional intervention). Without a data tool like the WEMR, clinicians can easily shift, or only assume limited, responsibility for a wound's condition.

The WEMR creates accountability for the wound and its condition, reinforcing wound healing protocols. It also decreases the overall provider hours spent documenting and retrieving information, since the chart page reviewed by the clinician is also a full supporting document necessary to substantiate a given treatment and support any billing. In addition to improved patient outcomes, this also yields substantial time-savings and decreased costs.

Beyond regular treatment regimes, the WEMR also permits realistic collaborations with nursing schools, medical schools, bioinformatics programs, etc., utilizing their vast resources and talents to disseminate wound knowledge via courses, Internet access, and peer review publications. All information gained (excluding private identifiers) can be made available to public sources, such as the National Library of Medicine, so all data, methods and technology are rapidly disseminated to advance wound treatment knowledge.

When implementing the WEMR, any suitable database platform can be used. In one embodiment, the WEMR is implemented on Microsoft® Access database platforms. To realize its full potential, more scalable systems like Microsoft® SQL Server are preferred. In more limited databases, storage capacity can be gained by storing images in separate directories with “pointers” to the individual location of each photograph residing in a field in each wound record. By using photo-editing programs like Adobe® Photoshop, a wide range of image manipulations are possible. Customizing the image may include software programming in Visual Basic to help automate control of the appearance of images in each report and form as required, even when stored separately. Other well-known processes, like standardized data entry forms, guided options (check boxes, drop down menus), drill-down capabilities and linked screens may also be used. For example, to enhance the accessible data while limiting the necessarily viewed data on a datasheet, the graphic elements (wound graph and photograph, radiograph and pathology photograph) may be enlarged when a user clicks on them, and simple buttons may be used to access and select from all the graphics and/or photographs stored on the computer related to a patient's particular wound.

Many practices today use local networks and remote access via virtual private networks (VPNs). The WEMR can be configured to run on any of these networks, be deployed on desktops, or be configurable by an individual user. Access is preferably limited to approved users, using techniques like authenticated network logon. Pre-existing data systems may store and present data from multiple, disparate databases. These may include, but are not limited to, legacy systems like the Eclipsys 7000 physician order entry and results retrieval system, the SCC lab system, IDXRAD and GE PACS (radiology information and imaging systems), TAMTRON (pathology information system), blood bank systems, anesthesiology records, and a host of disparate cardiology systems. Patient visits and demographic information may be included on yet other applications. Even where all the systems are available to a variety of users, they typically do not exist in a consolidated environment, and have a limited number of interactive modules permitting the input and review of patient information. On the other hand, the WEMR can advantageously include information from all the different information systems, allowing the information to follow the patient throughout the community, clinic, emergency room and hospital in a readily accessible form. All the pertinent wound information is automatically gathered in a single location on a single screen view, eliminating the need to visit multiple and disparate systems.

2. The Wound Database Module

The WEMR database module is designed to maximize data integrity while facilitating data entry and presentation to care providers. The module is designed as three separate relational databases: a backend database 101 containing the tables 102-107 storing all the medical data; and two front-end databases 108 containing forms, code, queries, macros, and modules, with the first a data entry database which facilitates and insures the integrity of the data entry, and the second a report database to produce the report that is ultimately viewed by a care provider.

The backend database, Wound Data, contains a number of different tables. Some of these are primary tables, used to store data; others store a collection of items used to populate drop-down menus for forms in the data entry database. The tables which store the data include but are not limited to: CBC, ChemsAndOthers, PatientInfo, tblAntibiotics, tblDebridement, tblPathology, tblRadiology, tblVascular, WoundCultures, and WoundData. The table which stores demographic data and is linked to most of the tables and queries in the other two databases is PatientInfo table 102.

The PatientInfo table 102 identifies each patient in the database, and contains basic demographic, medical history, and primary care physician information. Each record identifies a different patient, and contains a unique primary key called “PatientID,” which is automatically generated as a sequential number each time a new record is added to the database. Another unique identifier field in the U.S. is “Social Security Number,” which can also be used to link data for that patient in all the different tables, forms, reports and queries. This field (as with other fields with sensitive information) is formatted with an input mask displaying the normal Social Security number format (xxx-xx-xxxx), and is indexed to allow no duplicates or null fields. An additional unique field is typically used, storing the patient's medical record number. The “Location” field identifies a hospital or other facility with which the patient is primarily associated. An “Admission Date” field denotes the date that patient was first seen (and entered into the database). A “BirthDate” field stores the patient's birthdate as a Data/Time data type using an input mask to format as a short date. The “Last Name,” “First Name,” “Sex,” and “Age” fields are also inputted and stored. A “Race” field stores the patient's race as a chosen from a drop-down menu; “RaceOther” (explained below), “PtPhone” and “PtExtension” are also typical fields.

In addition to basic identifying information, certain history and relations information is also desirable. The name of the patient's of next of kin is added in a “NOK” field. The “NOKPhone” field stores the next of kin's phone number. A “PharmacyPhone” field stores the patient's pharmacy telephone number as a text field in the same telephone number format. “PrimaryCareMD” is a text field storing the patient's primary care doctor's name. “PrimaryCarePhone,” “PrimaryCareExtension,” and “Pager” are text fields storing that primary care physician's information, with the “PrimaryCarePhone” field using an input mask to display the normal telephone number format.

This table 102 also stores the patient's medical and surgical history. Several fields provide Yes/No type data fields, adding to ease of review. Among these are “Insulin,” “HTN” (hypertension), “VenousInsufficiency,” “Obesity,” “ASHD” (atherosclerotic heart disease), “ArterialInsufficiency,” “PVD” (peripheral vascular disease), “Venous Stasus Disease,” and “Atherosclerosis.” Text fields include “DM” and “AdditionalMedicalHistory.” The former includes the type of diabetes, and the latter allows the clinician to add any medical or surgical history not included in the above-mentioned data, including allergies and specific reactions to such allergies.

The illustrated WoundData table 104 is—implemented in nine tables in one embodiment of the present invention, The first of these, the CBC table, stores hematology and coagulation blood data. In this case the key field is “CBC_Unique_id,” which generates unique sequential numbers for each record. “Social Security Number” is a text field created with an input mask to display normal Social Security number format. “Date” is a Date/Time data type created with an input mask to display a short date type. “Social Security Number” and “Date” are indexed to prevent duplicates. “PatientID” is a number field displaying the number generated for the field of the same name in the PatientInfo table (generated when using the data entry form for this table). The following fields store hematology and coagulation data: “WBC” (white blood cell count), “Hbg” (hemoglobin), “Hct” (hematocrit), “Plts” (platelets), “PT” (prothrombin time), “PTT” (partial thromboplastin time), and

The ChemsAndOthers table stores chemistry, diabetic, and endocrine blood result data. The key field is “ChemsAndOthers_UniqueID,” generating unique sequential numbers for each record. “Social Security Number” is a text field created with an input mask to display normal Social Security number format. “Date” is a Date/Time data type created with an input mask to display a short date type. “Social Security Number” and “Date” are indexed to prevent duplicates. “PatientID” displays the number generated for the field of the same name in the PatientInfo table. The following fields are used, either with a number type field or long integer field: “Sodium,” “Potassium,” “Chloride,” “HCO3” (bicarbonate), “Glucose,” “BUN” (blood urea nitrogen), “Creat” (creatinine), “LDH” (lactic acid dehydrogenase), “HDL” (high density lipoproteins), “LDL” (low density lipoproteins), “Albumen,” “Total Protein,” “pre-alb” (pre albumen), “HbgA1c” (hemoglobin A 1 C), and “TSH” (thyroid stimulating hormone).

The tblAntibiotics table stores information about the patient's antibiotic usage, including antibiotic name, dosage, frequency, start date, stop date, and duration. The key field is “Antibiotic_UniqueID,” which is an autonumber data type. “Social Security Number” is again populated. “Antibiotic” is a text field, into which is entered an antibiotic name, dosage, and frequency. “StartDate,” “StopDate” and “Duration” are also used. “PO” (by mouth) and “IV” (intravenous) are Yes/No data types.

In similar manner the remaining tables, tblDebridement, tblPathology, tblRadiology, tblVascular, WoundCultures, and WoundData, store primary keys and the data fields related to their particular matters. The data fields used in an embodiment of the invention are more particularly illustrated by the input fields shown in FIGS. 6-12.

Finally, an images store 106 may be provided locally in database 101, or stored in other databases 109 with pointers from the wound database. The image capture and manipulation is discussed in more detail below. During the image capture process, tools like the WoundImager program may be used to automatically measure a wound, calculating the length, width, and area of a selected wound, with the resulting calculations automatically entered into the WoundData table. From the values stored in the WoundData table, a graph is dynamically generated for new report pages, thus reflecting each new data point as soon as that data is entered into the database. Similarly, graphs may be optionally provided to show trending information for hematology values, chem lab values, microbiology reports, etc. One convenient way of presenting such information is to allow a click on a particular value to imitate a screen with that value trending over a predetermined time period. Similarly, a microbiology report may contain both organisms and pharmacologic microbiology data, displayed in descending chronological order. By use of these graphic presentations, a reviewing clinician is provided with a real time summary of the wound healing trends, contemporaneous with the data entry.

3. Data Input

Turning now to FIGS. 2-13, a process is illustrated there for entering data into the wound database 101, together with exemplary input screens.

a. Patient Data Entry

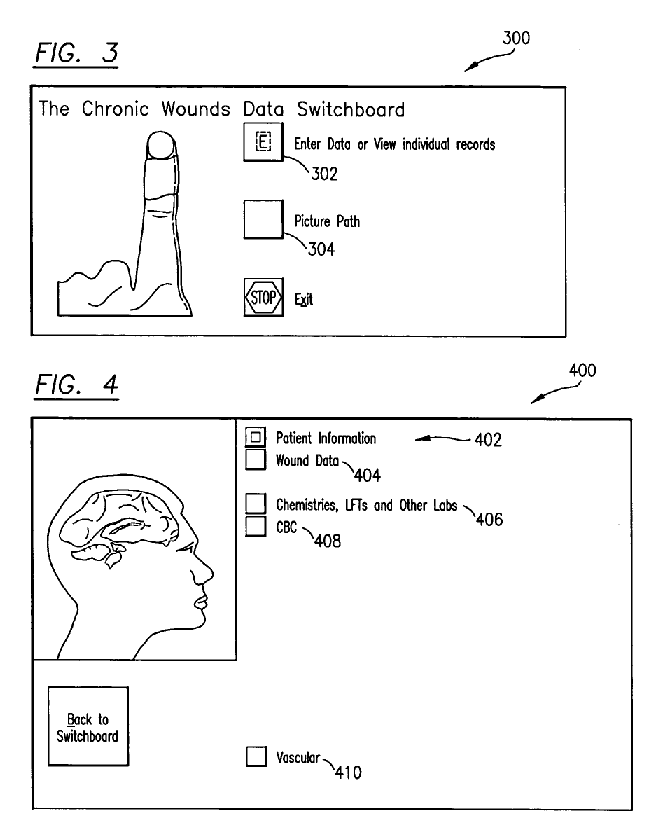

In the current implementation, information is added to the wound data database (backend database 101) via a “WoundsSmall” (data entry front end 108) database. The data entry process may be started by any convenient means for initiating applications, such as providing the user with an appropriate dB icon to double click, application menus, and the like. This process is usually proceeded by appropriate system authentication and access control checks, often performed as part of the network and/or terminal logon, or a logon page if using a browser for the user interface. (See steps 201, 205 of FIG. 2). In response to initiation of the database program, one or more selection screens are presented (300, 400 of FIGS. 3-4). From an initial “switchboard” screen 300, button 302 (“Enter Data or View individual records”) opens Universal Entry form 400 (FIG. 4).

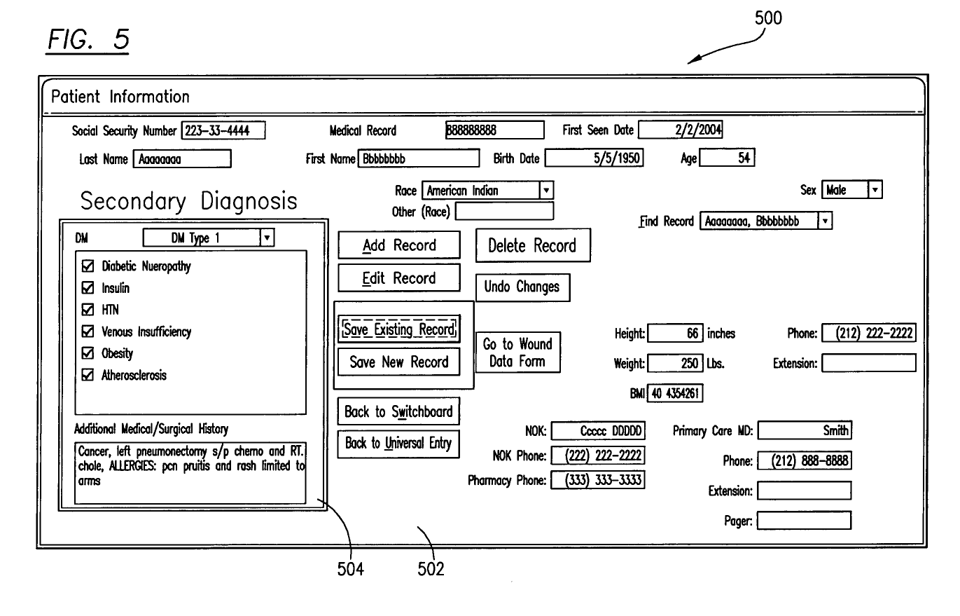

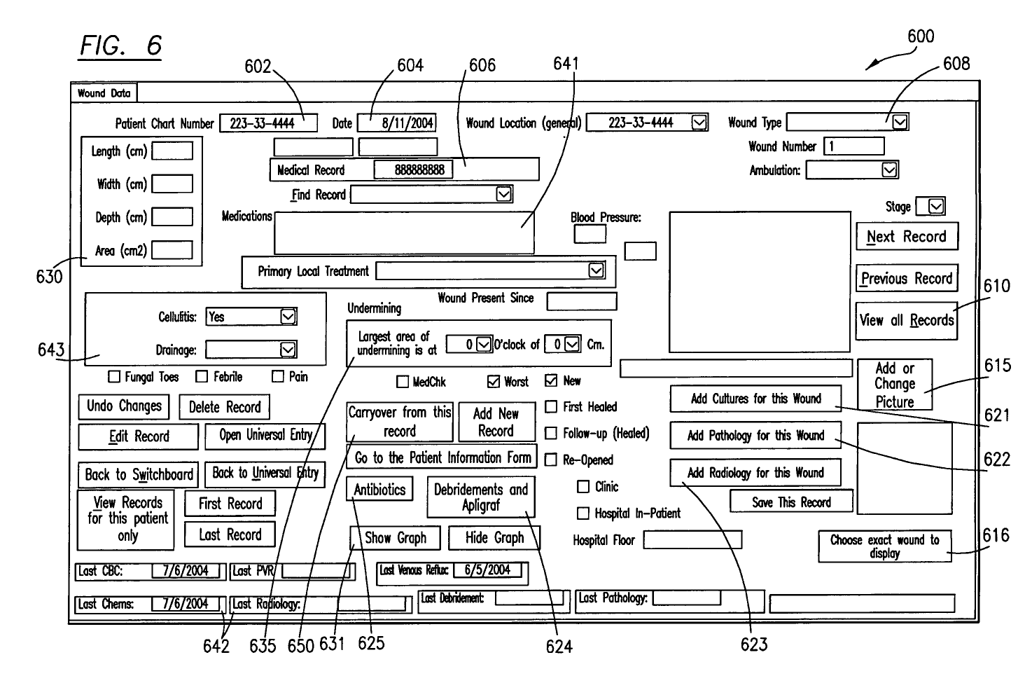

Before any data can be entered into any other form, a patient record must be opened with that patient's demographic data present in the “Patient Information” form 500 (FIG. 5). That patient's data need only be added once, but, it can be reviewed or changed as required. To open this form 500, the “Patient Information” button 402 is clicked. As can be seen from the Patient Information window 500, the following information can be entered via this window: Social Security Number, Medical Record Number, Date first seen, Last Name, First Name, Birth date, age, sex, race, Phone number, Primary Care Physician's name and phone numbers, height, weight, and medical/surgical histories. Those entries which are required to save the record can be indicated as bolded text or color coding, with user prompts if an attempt to save an incomplete record is made.

Several medical history entries can be added, using drop down menus or check boxes in Secondary Diagnosis field 504. Yes/No entries include Diabetes, Diabetic Neuropathy, Insulin, Hypertension (HTN), Venous Insufficiency, and Atherosclerosis. Obesity can be entered via a check box, or by filling in the Height (in inches) and Weight (in pounds) fields. When both height and weight are entered, the body mass index (BMI) is automatically calculated when the cursor is moved from either of those text fields, or the “Save Existing Record” or “Save New Record” buttons are pressed. The “Additional Medical/Surgical History” text box is for items not included in the in the check box and drop down menu of “Secondary Diagnosis” section 504. Patient allergies and reactions to those allergens should also be stored in this section.

Any record may be reviewed by selecting the patient's record from the “Find Record” drop down menu. Selecting that patient will immediately call up that patient's record. The record can be reviewed, but may not be changed unless the “Edit Record” button is pressed. This is true for all the data entry forms.

Once data has been entered for this patient in the “Patient Information” form 500, data for that patient can be entered into any of the other forms (Wound data, Chemistries, LFTs and Other Labs; CBC, or Vascular, FIGS. 6-13). To enter data into other forms, the user navigates via “Back to Universal Entry” or “Go to Wound Data” buttons. Delete and Undo options are also available, if the new patient record is not ready to be saved.

b. Wound Data Entry

The “Wound Entry” data entry form 600 (FIG. 6) is a more complicated and sophisticated window. Users are able to select existing records for any patient, and choose to view the latest entry of any wound for that patient. To open this form 600, one selects the “Wound Data” button 404 from the universal entry form (yellow arrow), or by selecting the patient's name from the “Find Record” drop-down menu of form 500. If more than one wound is present, the “Choose exact wound to display” button 616 will open form 700, listing each wound 701, 711, 721 in the database along with the location 702-704 and last entry date 706 for that wound. Pressing the “Go to this wound” button will display the selected record of that wound (for that date) on the “Wound Data” form 600.

In addition to data pertinent to a particular wound entry, wound data form 600 enables users to conveniently view, edit, and enter many items of data, both wound specific and patient specific. It can be used as a central navigation page for data entry. The wound specific items included on form 600 are: wound location, wound length/width/depth (630) and undermining (635), presence or absence of cellulitis and the amount of drainage (643), pain, fungal toes, microbiology data (621), radiology data (623), pathology data (622), and primary local treatment. Patient specific items include: ambulation status, current medications (641), debridement history (624), antibiotic history (625), and medical record number (606).

Along the bottom of the wound data form 600 are eight text boxes, each showing the last time data was entered in the wound data tables including CBC, Chems, PVR, Radiology, Venous Reflux, Debridement, Pathology, and Cultures. In the illustrated case of FIG. 6, the last Chems for this wound added to the database were entered on Jul. 6, 2004 (642), but the last venous reflux was on Jun. 5, 2004. This information alerts the viewer that the most recent values may not have been entered into the database. Thus, these text boxes provided convenient means for the viewer to check those items which may need updating while still in data entry mode, even though the data may be stored in other tables. In this manner staff or clinicians responsible for certain data entry functions can be prompted to attend to other tests, or remind other care providers, without needing to view a wound data note page (FIG. 14).

Several different types of records can be entered from screen 600. A new record can be either a new wound for an existing patient (that is, the patient has wound records in the wound data table, but there is no record for this new wound), or a wound for a new patient (there are no records in the wound data table for that patient). A new record for an existing wound (there is already a record of that wound for that patient in the wound data table) may also be entered.

When a new record is created in form 600, the next step is to define the location of the wound. This may be quickly done via a series of drop down menus that progressively narrow the location choice. Choice of a general location from the “Wound Location (general)” drop down menu prompts display of a second window. For example, if “Head” is chosen in the general menu, a new drop down menu titled “Head” will appear, with the choices: Occiput, Ear Right, Ear Left, Nose, Face, and Forehead. If “Ear Right” or “Ear Left” is chosen, another drop down menu will appear entitled “Ear Location” offering the choices Pina and Lobe.

Similarly, if “Trunk” is selected from the “Wound Location (general)” menu, a new “Trunk” menu will appear with the choices Abdomen, Chest Anterior, Chest Posterior, Gluteus Right, Gluteus Left, Ischium Left, Ischium Right, Sacrococcygeal, Scapula Left, Scapula Right, Trochanter Left, Trochanter Right, Perineum, Ilium Right, Ilium Left, Scrotom, Groin Right, Groin Left, Shoulder Left, Shoulder Right, Thoracic Spine Upper, Thoracic Spine Lower, Right Breast, Left Breast, Right Flank, Left Flank, Lumbar Right, Lumbar Left, and Lumbar Center. When “Upper Extremity Left” or “Upper Extremity Right” is chosen, two menus appear: “Upper Extremity” and “Location on Extremity.” “Upper Extremity” choices include Arm, Dorsum of Hand, Elbow, Forearm, Index Finger, Little Finger, Middle Finger, Palm of Hand, Ring Finger, Shoulder, Thumb, Wrist, and Axilla. “Location on Extremity” includes the choices: Anterior, Posterior, Medial, Lateral, and Stump. Selection of “Lower Extremity Right” or “Lower Extremity Left” returns choices Thigh, Knee, Popliteal Fossa, Calf, Fibular Head, Lateral Malleolus, Medial Malleolus, Heel, Instep, Foot, Medial Foot, Lateral Foot, First Metatarsal Head, Fifth Metatarsal Head, Large Toe, Second Toe, Third Toe, Fourth Toe, Fifth Toe, Sole, Ankle, and Achilles Tendon.

If there is more than one wound in the same location, where it is judged best for each wound to be treated separately, the “Wound Number” entry 608 can be changed from its default of “1” to an appropriate number, and the database will treat each entry at that location as a separate wound.

The next entry is wound type, which contains choices distinguishing the type of wound. Among these choices include Blanchable Errythema, Burn, diabetic Foot Ulcer, Hererotropic Osteotation, Inflamatory Wound, Ischemic Ulcer, IV Extravasation, Post-Operative, Pressure Ulcer, Skin Tear, Traumatic Ulcer, and Venous Stasis Ulcer. The date the wound was first noted should also be filled in the “Wound Present Since” field.

Wound specific data may then be entered. This includes the data in field 630, including Length, Width, Depth, and Area (area may be automatically calculated). Undermining is added via a drop-down menu and text box 650, the first identifying the location of greatest undermining, the second identifying the extent of undermining.

Other general wound characteristics may be added, including the presence or absence of cellulites and extent of wound drainage at block 643. Simple scales may be used, or greater detail can also be given prompting a choice from an established protocol (e.g., Minimum-only a spot on the dressing; Mild—dressing stained only to the extent of the dimensions of the wound; Moderate—dressing stains greater then the dimensions of the wound, but dressing is dry; Copious—dressing stained and wet; or a Braden scale; etc.). If the patient has any pain associated with the wound, has evidence of fungal toes, or has been running a fever, the appropriate check boxes below block 643 should be used. Topical wound treatment is entered via the “Primary Local Treatment” menu. If the particular treatment is not on the menu, typing in the treatment and then moving the cursor to a new field will bring an information box stating that the treatment is not on the list, and asking if you want to add that treatment to the list.

A complete list of the patient's current medications should also be entered. Given the range of medications, this is typically entered in text form (e.g., name, dosage and frequency, with common terms like ac, pc, QD, BID, TID, Q6H; HS, etc.) Default routes need not be noted (e.g., by mouth (PO)), but others should be (IV, IM, PR, IT, PV.) In lieu of drop down menus, this can be automatically populated from other related data stored for that patient in the facility's systems (such as database 109 of FIG. 1). In addition, the patient's ambulation status and blood pressure should be entered.

The image location (where the photograph is located on a local or networked drive) is entered by pressing the “Add or Change Picture” button 615, which calls up an explorer type dialogue box and a default drive/folder. The user may then navigate to the correct directory, and select the appropriate (e.g., most recent) picture to add. Once selected, the photograph will appear on the “Wound Data” form. Alternatively, intelligence can be added to the photo capture program so that as new photos are added to the file for a given wound, the relational link with the Wound Data form 600 is updated to point to the new photo.

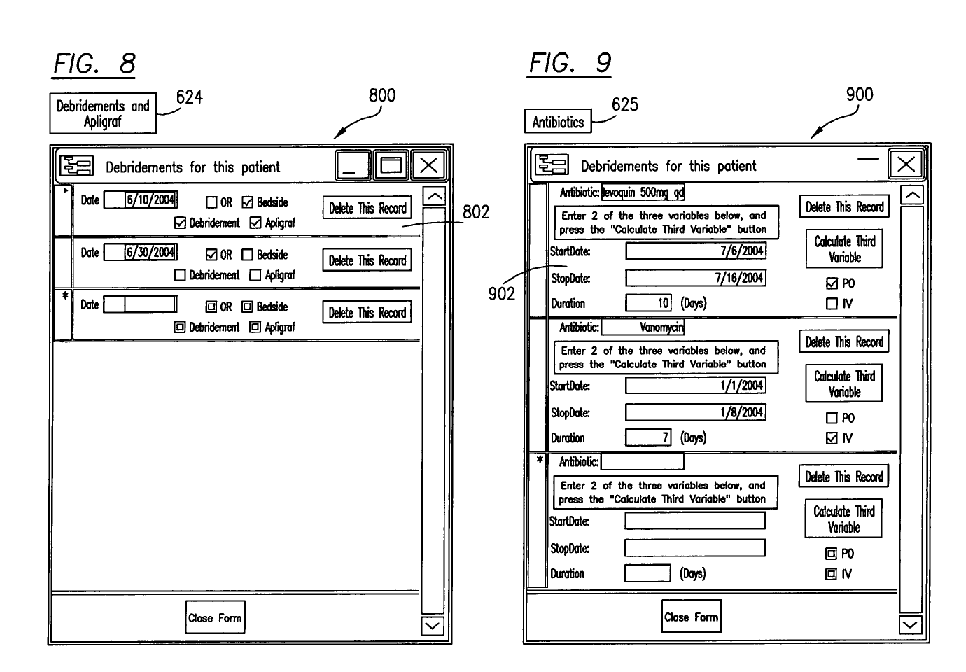

Wound debridements and applications of Apligraf or other biologics are also tracked, and new dates entered, by pressing the “Debridements and Apligraf” button 624. This brings up form 800, shown in FIG. 8. A new debridement date can be entered in the blank record 802, along with check boxes for the appropriate data such as Debridement, Apligraf, OR (if procedure was performed in the operating room) and Bedside (if the procedure was performed at the bedside (or in clinic). Other selections, based on different protocols or treatment options, can be readily added to this form and created in the table space. For example, other FDA approved biologicals for use in healing diabetic foot ulcers currently include Regranex and Dermagraft. Since different cellular and growth factor therapies are distinct and function by sharply different mechanisms, the protocol design rules for data entry can be used to prompt different options, based on the other wound characteristics already selected. For example, common to the three biologicals noted here is the requirement that they should not be used in the presence of drainage, infection, or without debridement. If the selections entered for these values is contrary, an alert can be provided to the user, prompting correction of other data entered, or reconsideration of a proposed therapy.

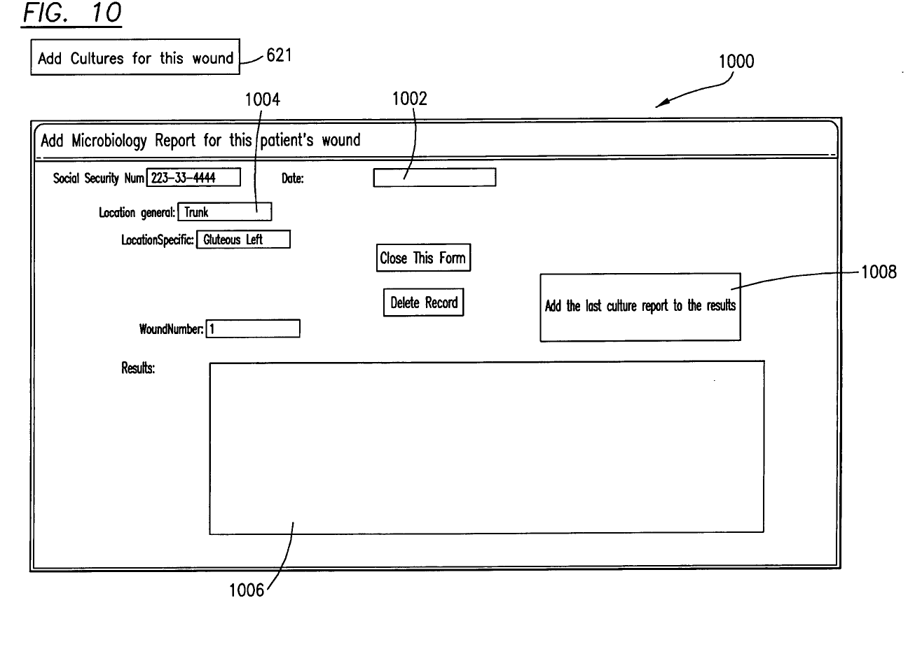

The patient's antibiotic usage can be reviewed and modified by pressing the “Antibiotics” button 625, which brings up form 900 (FIG. 9). The antibiotic name, dosage and frequency are then entered into the “Antibiotic” field. The appropriate route is then indicated (PO or IV), and at least two of the remaining three fields completed, i.e., “StartDate” “StopDate” and “Duration” (the third variable may be automatically calculated and entered.)

Microbiology, Pathology, and Radiology data for the specific wound should also be entered from the “Wound Data” form, if available. The microbiology data entry is initiated via button 621, which opens form 1000 (FIG. 10). The two fields which are enabled (so data can be entered) are “Date:” and “Results:” If there are no previous culture results, the “Add the last culture report to the results” button will be greyed-out and state that there are no previous results available. If there are previous culture results in the database, “Add the last culture report to the results” button 1008 will be enabled (text not grayed out, and button functional); pressing this button will open a form containing the previous results. These results may be added to the new Culture Report, in which case the existing data is pasted into form 1000. The date of the cultures is then entered into the “Date” field, and the culture results (organisms and sensitivities) to the first line of the “Results” field. If either the “Date” or “Results” field lacks data, the user can be alerted and safeguards employed (e.g., so closing the form will not add the new record.)

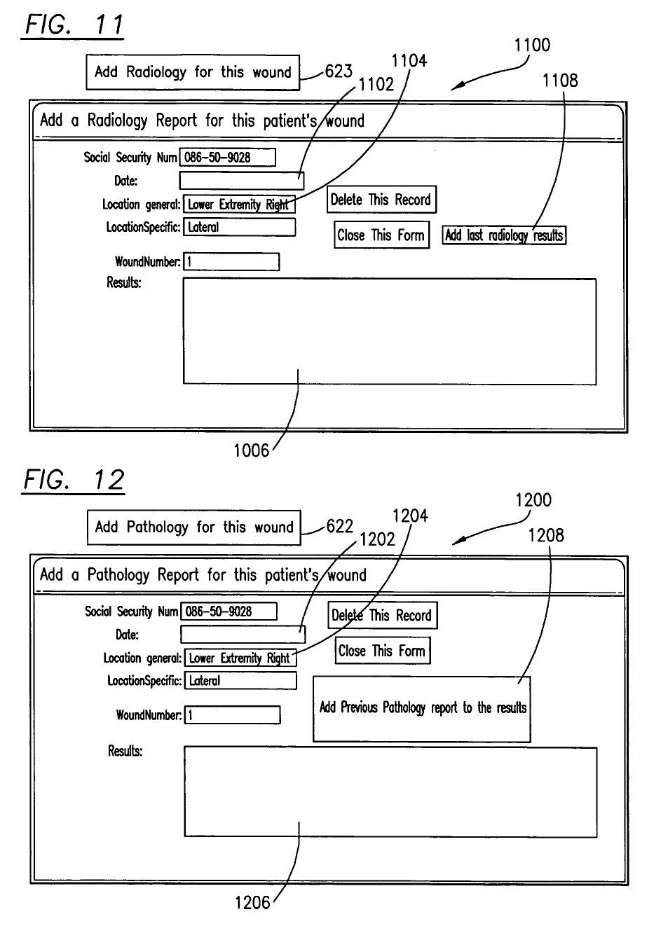

Similarly, new radiology results for this record are added by pressing the “Add Radiology for this wound” button 623, which brings up form 1100 (FIG. 11). New pathology results are added via the “Add Pathology for This Wound” button 622, which bring up the form 1200 (FIG. 12). Previous results may be added to both forms (see buttons 1108, 1208), as with the microbiology form 1000. Dates (1102, 1202), location (1104, 1204) and new results (1106, 1206) are similarly added. If there are no results, press the “Close this Form without adding these results” button, which selects the previous form.

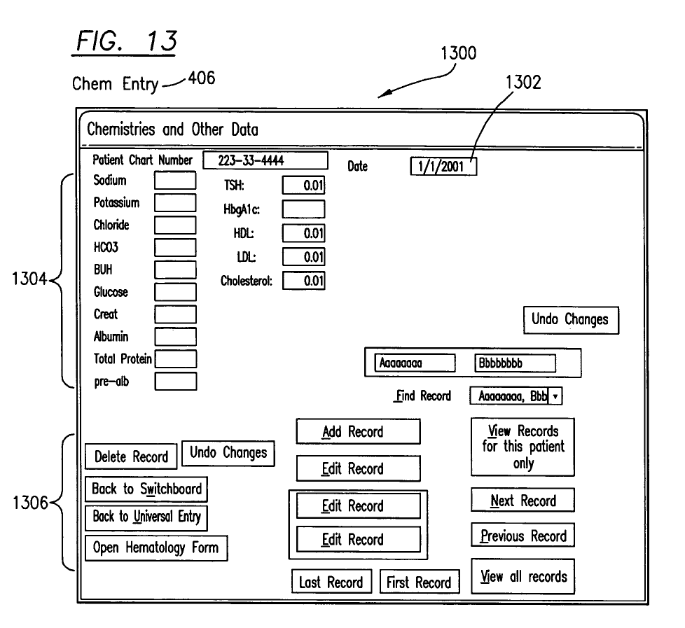

To enter chemistries, one presses the “chemistries, LFT's and other labs” button 406 of menu 400. The chemistries form 1300 then appears (FIG. 13). The patient is selected from the drop down menu “Find Record,” which brings up the first record for that patient. To review records for only that patient, the button “View Records from this patient only” is clicked. Other navigation buttons may also be provided. This form also accommodate a variety of laboratory values. In this exemplary wound treatment, the values include, but are not limited to: sodium, potassium, chloride, bicarbonate (HCO3), blood urea nitrogen (BUN), glucose, creatinine (Creat), albumin, total protein, prealbumin (pre-alb), thyroid stimulating hormone (TSH), hemoglobin A 1c (HbgA1c), high-density lipoproteins (HDL), low-density lipoproteins (LDL), and cholesterol. The database can accommodate a virtually unlimited number of entries for each patient. As with other values, one could provide graphical displays to show trends based on user-selected lab values.

When a record of a patient's wound already exists in the database, some data should be automatically carried over from the previous record, reducing redundant data entry. This includes patient identifying information such as a Social Security number, as well as information that does not regularly change (e.g., wound location, wound type, ambulation status, and medications). This can be accomplished via the “Carryover from this record” button, if selected within a display from a desired prior entry. This opens a new record with the appropriate information filled in already. The remaining data is entered as described above.

c. Photo Capture and Manipulation

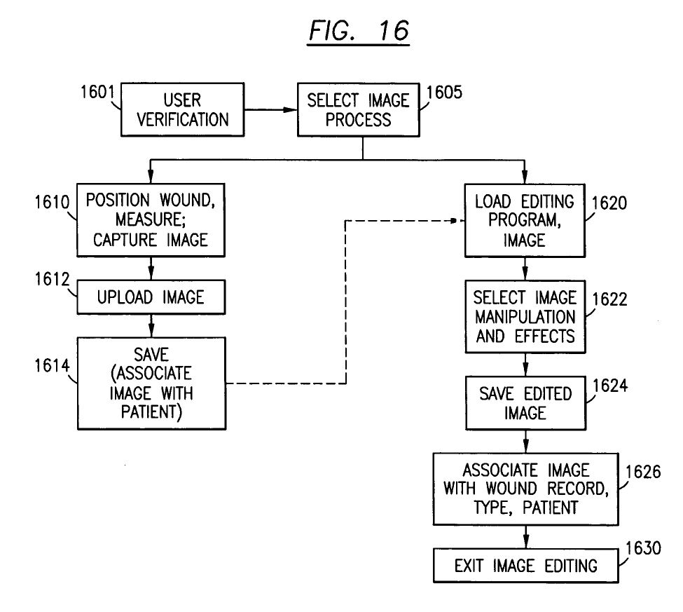

The WEMR is designed to display the most recent photograph of a particular wound, along with its measurements. See FIG. 16. In accomplishing this, any one of the many well known or proprietary image capture systems can be used. Many large hospitals have some form of electronic record keeping that assists in capturing images-photos, x-rays, etc.—and stores them in a patient indexed database. The WEMR can be easily adapted to use these preexisting processes and databases (steps 1614, 1626). It can, for example, copy selected information from these databases, or just use pointers or similar techniques to retrieve the image data only when a user views a record, thus avoiding redundant data storage. For smaller office and outpatient settings, off the shelf digital imaging devices (ag. inexpensive 2 megapixel to 6 megapixel digital cameras) and photo manipulation software programs (a Adobe® Photoshop® or Microsoft® PictureIt!®, for rotation, exposure, sizing, etc. (steps 1620-1624)) can be adapted to capture images at the desired quality and store/catalog these images for later retrieval (steps 1610-1614). Determining wound dimensions is aided by capturing a ruler adjacent to the wound when taking the picture. More specialized software like WoundImager allow automated measurements based on the captured image, and a variety of database products from standalone to enterprise level systems are available for the image storage and retrieval. Particular techniques for photographing, storing, and manipulating the data for improved image quality, are matters of routine skill and choice for care providers and their staff.

A particularly advantageous feature of the WEMR approach is its intelligent use of regularly updated wound photographs, tying the initial views of wound data records to the most current image. To accomplish this, when a patient arrives for a consult, all wounds are photographed by the nursing or other clinical staff as a routine part of clinical care. The same occurs for hospitalized patients, with nurses or other staff taking pictures regularly at the bedside as a routine part of their care.

In serving the images for a care providers viewing in a WEMR report (like the Wound Assessment and Progress Note of FIG. 15), more than one image is preferably displayed. The most current image should be used in almost all cases, but a clinician may also find it useful to have earlier images for comparison. The WEMR is arranged so one may readily select which additional images to display. A typical approach to showing two images is to make a first selection of the wound at its worst, and carryover that image to all subsequent reports. In this way, clinical decisions are facilitated by allowing a quick comparison of the current versus worst view, providing a pictoral view of the progress obtained.

3. Review and Approval

Because the WEMR wound data database is kept current through regular updates, it is possible to serve up current and complete documents for review and approval by medical service providers. A layout for a single page Wound Assessment and Progress Note is illustrated in FIG. 14, and examples for several distinct wound types are illustrated in FIGS. 15 and 21-22.

In the report, all pertinent data required for sound wound management consideration are presented in a single page view. See Progress Notes 1500, 2100 and 2200. This insures that the wound care provider is alerted to subtle changes in wound healing, and can take earlier corrective action if needed. Since the data selected for viewing is protocol-driven, it also insures that all protocol required data is considered with each viewing, and that a clear record of what was considered and done is maintained for medical records and billing purposes. In practice, this means that non-physician care providers are able to off-load time-consuming and potentially distracting record-keeping requirements from physician reviewers, by inputting substantially all required data preparatory to a physician review. The reviewing physician will still confirm the accuracy of data as needed, but he or she is now able to focus better on the meaning of the data and treatment of the patient. The WEMR system not only improves the quality of records; it also improves the quality of care while significantly reducing a physician's time lost to billing and documentation.

In one embodiment of the invention, a layout for a typical Assessment and Progress Note page is shown in FIG. 14. All the data items desirable under the relevant treatment protocol are organized in a reviewer-friendly format. Examples of specific data types are discussed above. The general categories, which in some cases are associated with particular data table types, include: patient identifier information 1402; image(s) 1404; patient history and medications 1406; wound dimensions graph 1420; wound culture data 1425; venous reflux 1435; PVRs 1440; wound pathology data 1430; chemistry values 1445, 1466; radiology data 1450; and debridement/biologicals data 1455. Specific fields and examples of entry displays can be seen in FIG. 15. Thus, items from the PatientInfo table are placed at the top of the page, including the patient's ID, physician information, treatment facility, and the like. History and medication would include specified prescription drug information 1406, ambulatory status 1408, subjective pain, drainage data 1410, indication for biological treatments 1414, and cellulitis 1416. The wound graph 1420 illustrates one possible graphic display of dimension trends over time, although other graphical displays could be used as a matter of design choice or user preference. Comments are part of many fields, as can be seen in wound culture 1425 and pathology 1430, and the comments are listed starting with the most current. Because Assessment 1400 will become part of the patients record, a reviewers approval/signature block 1470 is also included. Of course, the actual position of the information fields is a matter of mere design choice, although consistency and standardization is valuable in assisting a clinician's rapid review of the reports.

Information on the Assessment page is preferably conveyed using more than just the black and white and fixed presentations that appear in FIG. 15 (which is limited by the current requirements for patent applications). Some of the digital media enhancements available start with the selected use of color codings to convey information to the care provider. Because too many special conventions risk misinterpretation, these should be used in a selective and limited manner. But common conventions can add significant value to the Assessment. For example, in a preferred embodiment, chemistry values that are above a predetermined threshold, considered abnormally high, are represented in red. Low values can be represented in green. In doing so, abnormal values are highlighted for the reviewer, helping insure they are not overlooked when reviewing the data. Because this is automated, the selected values are protocol-driven, and stay current with any changes in the underlying protocol. It is also possible to highlight a group of numbers which, individually might not be considered problematic, but when taken together are above a predetermined set of values, and should be more closely considered. Other colors, denoting additional information, may be desired by some practitioners. In addition to color coding, an electronic Assessment report lends itself to well-known viewing tools such as window scrolling or expansion, content substitution, or animations. In the case of prolonged treatments, the text data for fields like pathology may quickly exceed the area of view box 1430. However, by clicking on the field, a scroll bar or expanded window can provide a convenient mechanism for a reviewer to retrieve and consider past history and treatment, if desired. Similarly, clicking on or hovering over current chemistry values could be linked to retrieval of a pop up window with a trending graph of the selected value(s). Clicking on an image could prompt options such as expanding the view, substituting or giving a slide show of past image(s), or even opening video images.

If the care provider is satisfied with the report 1400, and has finished the patient consult, the Assessment is then approved (step 226). If a copy has been printed, then the Assessment would be signed the same as is done with other medical records. Electronic signatures or other verifiable indicators of approval may be used if the review is performed electronically. If comments need to be added to the report, a number of techniques may be used to facilitate data entry. For example, clicking on a text field could return an option to add new data via a pop up window; when closed the Assessment is automatically updated to reflect that data as the most recent, on the current date. As technology alternatives like voice recognition mature, these can also be integrated into the data input process for greater convenience and efficiency. Similarly, if changes are desired in the medications, these can be entered as changes in the medication field 1406, while the input data can be simultaneously populated into a separate order fulfillment program.

Once approved, a permanent copy of the report is preferably captured and stored. This is done to provide a fixed record of what was reviewed on that date, both for compliance and billing purposes. Copies needed for other systems (like the billing records 132 of payor 131) may be transmitted automatically to the predetermined recipients, based on user selection or other patient and care provider information profiles stored in the WEMR or related clinic/hospital systems (steps 227, 228).

4. Consults, Studies and Training

In addition to serving as a real-time system for medical record data input and review, the WEMR also facilitates extended activities such as consults, studies and training. In the case of consults, third party consultations are easier to achieve since the report data can be provided over a remote network as readily as a local network. A browser enabled interface to the WEMR permits secure (e.g., SSL) connections to protect the privacy of data in transmission. The treating physician has limited authority to grant temporary privileges to third parties, in the form of a temporary ID and password. In most instances, the privilege would be for a single patient, set to expire within a short period of hours, and could be set to accept a single SSL connection to safeguard against multiple logins on different platforms. In this manner, a specialist or other remote care provider can be logged on and viewing the same complete file as the treating physician in a matter of minutes. Since this physician has his or her own ID, the WEMR report will differ in so far as this physician can be listed as a reviewer in his/her own right, with their Assessment being approved, saved and forwarded as would be the case for any other reviewer. If desirable, other computer collaboration tools can also be used in conjunction with a WEMR consult, including chat, whiteboard, computer conferencing, and the like.

The WEMR system can also provide the informational foundation for extended wound healing studies and training. Since the WEMR will be aggregating a wealth of wound healing and protocol efficacy data, it becomes a key source of data mining for studies and training about wound medicine. In order to safeguard patient privacy, any extended searches can easily mask the fields containing key personal identifiers, while still permitting searches across all the other pertinent fields. Searches could be performed by any of the many well-known search techniques, with variations depending on the types of databases used (Access, vs. Oracle, vs. object-oriented, etc.) Straightforward menu-driven searches can be performed using forms similar to those of FIGS. 6-13, where values for selected fields are chosen by pull-down choices or input of ranges, key terms, etc., and all records matching those criteria being returned (see steps 232-234). This could also be implemented as an added feature to use with regular patient treatment if needed, where the treating or consulting physician uses a search for similar cases, looking for correlative wound issues and successful treatment regimes (steps 224-225, 230).

For major studies, leading educational institutions or national medical organizations may want to facilitate networked access or aggregate wound care data from around the world. The WEMR makes this feasible. By driving evidence-based protocols in an electronic data environment, more or less standardized data fields will lend themselves to better sharing between wound centers and other medical care facilities. The data can then be shared so searches across the participating databases (or at least mirrored and privacy masked copies) can be performed by privileged users. Alternatively, the masked data could be regularly exported to a trusted repository like the National Library of Medicine, which would aggregate the data and provide the common platform for mining the wound data.

Of course, to properly evaluate any study on wound healing, adjustments for the certain variables may be needed. Some of these may include: race; ethnicity, gender, age, nutritional status (e.g., albumin and prealbumin); obesity (specifically, body mass index); type 1 or type 2 diabetes; hemoglobin A1c in diabetic patients, cardiac disease as defined by history of ischemia, use of antibiotics, pain status as determined by objective parameters, and quality of life measurement. Since all of these variables are captured via the WEMR, the effect of these same predictors can be easily evaluated and individual records adjusted for purposes of a study. Other (e.g., hospital-based) predictors can also be applied (e.g., chemotherapy, long operating time, deep vein thrombosis, and myocardial infarction) upon discharge using the same techniques.

The WEMR enables the data to be better mined, and as such, it can also be used as part of an educational program. Individual cases can be followed after the fact and in detail, so newer practitioners can follow (and be tested against) the course of a wound treatment by advancing through the reports and other records. Further, groups of records can be studied, e.g., to help reinforce the differences and commonalities related to selected issues. More complex training tools can also be implemented using “ideal” or artificial datum added to a set of training records. In this manner, a practical “what-if” training tool can be made, allowing care providers to create records with alternative outcomes, based on the treatments selected by the student. For example, a choice whether to debride or not can be made and promptly returned with the next “Assessment,” showing the consequences of the selected treatment. Once a sufficiently large set of validated data has been aggregated, this “what-if” training can be extended into a true expert system, where practicing physicians are able to load actual cases and test against statistically significant samplings, e.g., to understand better the likely efficacy of different treatment options of substantially the same wound healing scenarios. This would prove a particularly beneficial tool when studying new treatments and protocols across multiple wound centers, allowing for much more rapid approval (or abandonment) of innovative treatments.

5. Template and Protocol Development

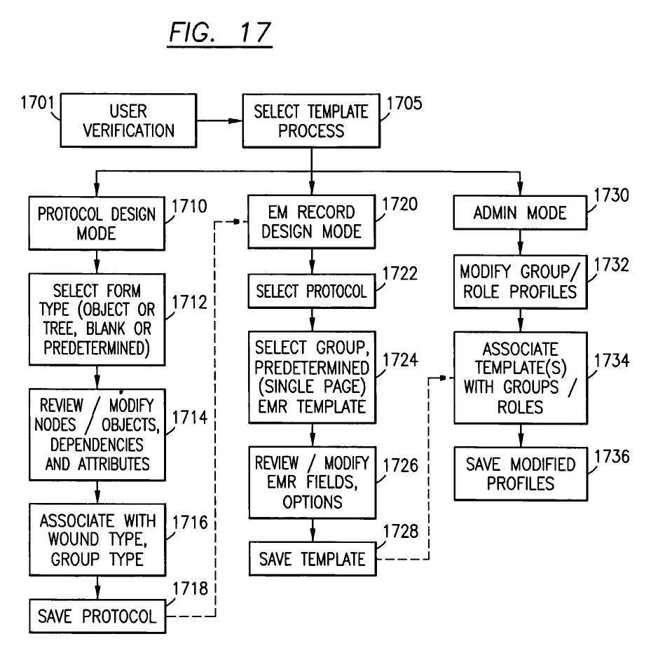

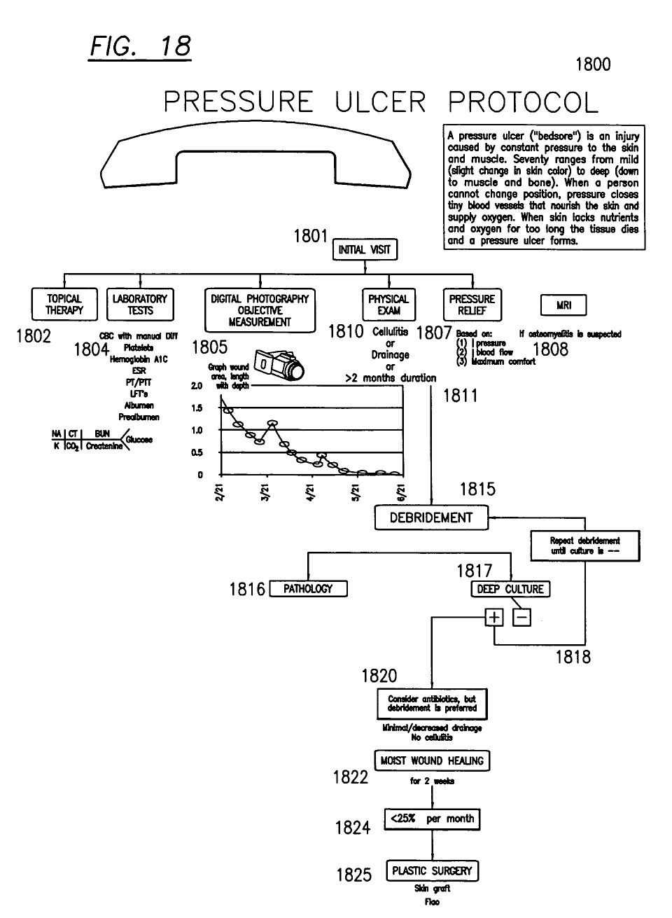

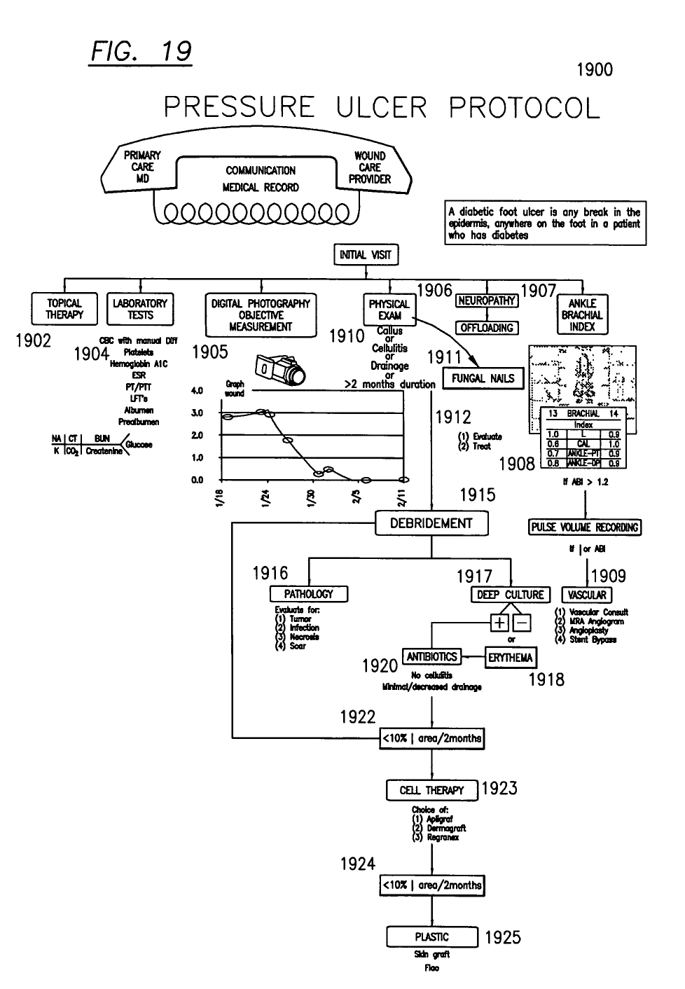

Turning to FIG. 17-20, a high-level view of a process for managing the templates and protocols used in connection with the WEMR is illustrated. In the simplest case, the various templates are individually created from the design tools present with most database products. Starting from scratch, a typical design process would begin by formalizing the protocols being used with the WEMR. Two such protocols, illustrated as simplified flow charts, are shown in FIGS. 18 and 19, and a longer example described in detail below. As might be expected, these protocols for treating different types of ulcers have a number of common elements, but also have unique ones. For example, both protocols call for similar lab tests (1804, 1904), imaging (1805, 1905), and exam/debridement (1810-15, 1910-15) processes. On the other hand, an ABI (ankle brachial index) and vascular treatment (1907-09) are only called for as part of the diabetic foot ulcer protocol, while an MRI is an indicated diagnostic tool (if osteomyelitis is suspected) under the pressure ulcer protocol (1808). When taken together, all the protocols indicate the types of data that should be considered in the course of treatment, together with therapies and treatment options; these in turn define the type of data that needs to be collected in the WEMR in order to effectively implement the protocols.

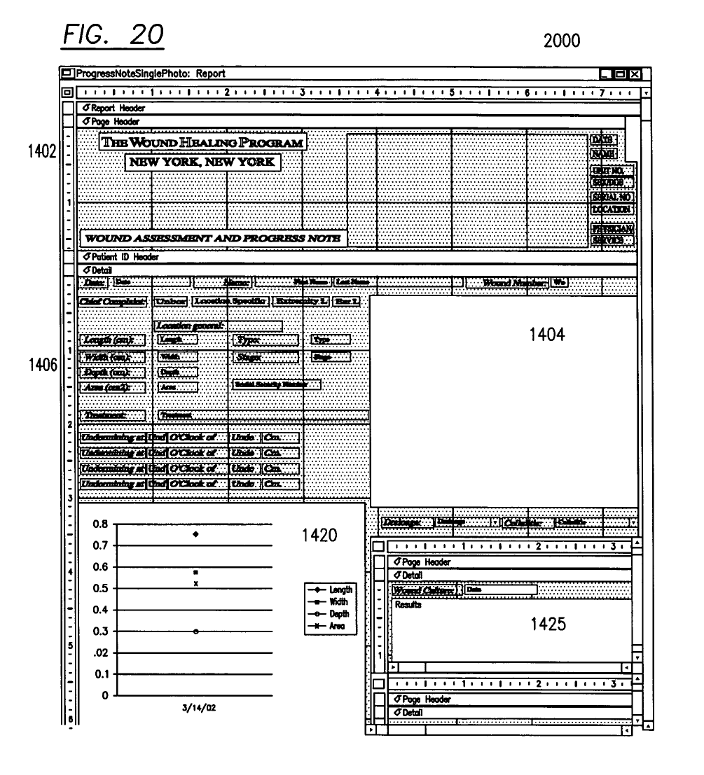

Once the types of data are identified, then the database tables, fields, input screens and reports can be developed. FIG. 20 shows a partially complete “report” design view, such as might be found when using windows-based databases like Microsoft Access. In this case each of the tables and fields have already been created, with appropriate field types to support the text, number, date, multimedia, or other data forms being stored in the respective fields. The “report” is then designed by inserting each data field, together with its title, at the desired location on the “report” page. These same fields shown in FIG. 20 (e.g., image field 1404, wound culture 1425, etc.), become the data fields populated in the reports like FIG. 15 when presented to care providers.

Once the first report has been created, further reports can be more easily created by copying the first report, and deleting unnecessary fields and adding any new ones. In other words, these can become the templates embodying the protocol data reports (and data input, in the case of entry forms), which may be used for related data, shared with other care provider systems, and generally facilitate a better dialog about the processes of information flow, recognition, recordation and validation in would healing.

Along with the database templates, the underlying protocols can also be stored and associated with wound treatment records. In this manner the protocols elements that are not prompted or visible via the WEMR data entry or report pages can still be readily accessed while reviewing a wound record. The full protocol can also be accessed later by others (e.g., in studies) to consider secondary factors that may have impacted an outcome. Some of these may include the periodicity of exams (e.g., daily exam of high risk areas like the heels, ischial, trochanteric, and sacral of every bed bound patient), periodicity of preventative measures (e.g., turning patients every two hours), etc. For ease of comparison, all or some of the protocol options may themselves be placed in a protocol table, permitting greater flexibility in searching and empirically testing the impact of variations in secondary factors between similar protocols.

An example of a more detailed protocol, designed in conjunction with the superior informatics tools offered by the WEMR, is the following protocol for ulcer treatment:

### EXAMPLE

### Pressure Ulcer and Diabetic Foot Ulcer Protocol

a. Recognition that all patients with diabetes or limited mobility are at risk for sacral, ischial, trochanteric,or heel pressure ulcers. All patients with diabetes and those at risk for localized pressure ulcers (i.e., spinal-cord injured and bed or wheelchair bound patients) should be examined daily in all sacral, ischial, trochanteric, heel, and foot areas. Any new wound (i.e., any break in the skin) requires mandatory and immediate intervention.

b. Daily examination of the skin on the heels, feet, pelvis, and sacrum in bed-bound patients and those with diabetes.

c. Initiation of a treatment protocol immediately upon recognition of a new wound. All underlying medical conditions must be treated by the primary care physician, who needs to maintain continuous communication with the patient and other clinicians caring for the patient. Recognition that a chronic wound has an underlying physiological impairment to healing is essential in designing a treatment plan. Initial recognition of a diabetic foot ulcer should prompt an immediate visit with the patient's physician, podiatrist, or surgeon. As soon as an ulcer is recognized, an immediate and comprehensive treatment should be initiated with the clinical endpoint of healing, unless other mitigating factors (e.g., palliative care) are documented in the patient's chart. The healthcare provider(s) responsible for treating the wound should have a choice of interventions that includes the entire range of all available therapies. No patient with any chronic wound should be advised to remain in bed. If a patient is on a ventilator or otherwise bed-bound, physical therapy should be immediately initiated. This approach not only helps accelerate wound closure, but decreases other co-morbidities associated with bed-bound patients (e.g., pneumonia, new additional ulcers, and deep vein thrombosis).

d. Objective measurement of every wound weekly with digital photography and planimetry, and thorough documentation of the wound's progress. Once weekly, the length, width, and depth of the wound must be measured in all patients as a mandatory part of the protocol regimen. Planimetry is optimal for calculating the length, width and area; and a Q-tip may be used to measure depth and undermining.

e. Effective wound-bed preparation and establishment of a moist wound-healing environment. Wound-bed preparation is considered adequate only after all scar tissue and infection are removed. Wound-bed preparation should be directed toward creating a moist wound-healing environment, while facilitating granulation tissue formation (i.e., new collagen formation and angiogenesis) and decreasing bacterial load in the wound. During surgical preparation of the wound bed, the wound margins should not be extended more than several millimeters into healthy tissue. The goal of wound-bed preparation is to have well-vascularized granulation tissue without signs of local infection, which include drainage, cellulitis, and foul odor. Topical treatments have been shown to enhance wound-bed preparation. Osteomyelitis merits special consideration. By definition, ulcers that penetrate to visible bone have osteomyelitis.

f. Relief of pressure from the wound. Pelvic pressure ulcers, heel ulcers, and diabetic foot ulcers are caused, in part, by pressure. However, the term “pressure ulcer” is a partial misnomer because it is not only pressure, but also a combination of factors that cause ulcers, including decreased blood flow. Crucial to remember is that sensory loss, which occurs in diabetic neuropathy, permits pressure of any magnitude to be applied to the ulcer without the pain or discomfort experienced by individuals with normal sensation. Therefore, it is critical to ensure that pressure is relieved from all wounds, both diabetic foot ulcers and pressure ulcers. For diabetic foot and pressure ulcers, offloading remains the absolute minimum standard of treatment for relieving pressure.

g. Debridement of all non-viable tissue in the wound. Debridement is performed to stimulate healing and accelerate contraction, and is a mandatory part of the clinician's protocol regimen. Several methods of debridement can be used. Small ulcers may be debrided at the bedside, whereas more extensive ulcers need to be debrided in the operating room. Debriding any wound to the level in which scar, non-viable tissue, and infection are no longer present—even if down to the bone—has proven to be safe and therapeutic. Only a minimal amount of viable tissue should be excised. The wound margins should not be extended more than 1 mm or 2 mm.

h. Elimination of all drainage and cellulitis. Cellulitis occurs when infection from the ulcer spreads to surrounding tissue, is serious, and frequently complicates pressure ulcers that were not treated effectively. All cellulitis must be eliminated, by using moist dressings, antibiotics, and surgery. Drainage, another possible sign of infection, must also be eliminated. A successfully healed wound has neither cellulitis nor drainage.

i. Consideration of biological therapies for patients whose wounds do not heal rapidly after initial treatment. Biological therapies include growth factors and cell therapies. Cell therapy adds cells and growth factors to an environment deficient in cells and/or growth factors.

j. Aggressive nutritional supplementation for all malnourished patients. In addition to protecting healthy skin from damage, good nutritional status is essential for healing pressure ulcers. A holistic assessment of nutrition must include glucose, vitamin, and protein levels. Diet must be adjusted to each individual patient's needs. Therefore, if a patient is malnourished, a comprehensive regimen must be implemented immediately. Blood tests and body-weight measurements are taken regularly to ensure maintenance of proper nutrition. Any patient whose albumin or pre-albumin levels are not normal must have a documented treatment plan implemented. After the patient leaves the hospital, they should be educated to assess and maintain their nutritional health.

k. Elimination of Pain. No patient should be in pain. Objective weekly recordings are mandatory. Pain treatment in the wound patient is multifaceted but straightforward. Documentation on the WEMR is mandatory.

1. Physical therapy. Physical therapy is important for all bed-bound and physically impaired patients especially those with pressure ulcers. Physical therapy is important to 1) prevent contractions; 2) decrease the chance of deep vein thrombosis; 3) decrease respiratory complications; and 4) increase mental acuity.

Finally, one of the benefits of the WEMR is that the improved data collection and protocols used have allowed some success in establishing an expected rate of healing for various wounds. Once more broadly tested and reviewed, such protocol and evidence-based studies can yield standardized rates. This in turns will aid the patients in better understanding the course of healing, and can serve as an indicator for further study if the expected wound healing rate is not achieved.

Of course, one skilled in the art will appreciate how a variety of alternatives are possible for the individual elements, and their arrangement, described above, while still falling within the spirit of the invention. Thus, for example, other infrastructure (satellites, televisions, network terminals, etc.) can be used in addition or in lieu of the examples shown in FIG. 1 for a WEMR system. Highly networked, enterprise level systems, web services, or proprietary or standalone versions can all be implemented, using the teachings disclosed above. The particular data, as with the treatment options, will change over time and in many cases, is a matter of design choice. While certain data types described above are considered important to wound healing protocols like those for treatment of ulcers, the invention described here can have broader application to any multidisciplinary medical protocol, since the WEMR described can readily be extended as an informatics platform to help integrate and present key data for other disciplines like oncology, cardiology, etc.

While the above describes several embodiments of the invention used primarily in connection with the wound healing processes, those skilled in the art will appreciate that there are a number of alternatives, based on system design choices and choice of protocol options, that still fall within the spirit of the claimed invention. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments.

I claim:

1. A method for managing wound data, comprising:
a) storing patient information in a wound data record, the patient information comprising the following data types: a wound picture, a wound healing rate graph, a wound treatment descriptor, a medication descriptor, a patient identifier, and a review indicator; and
b) retrieving and presenting at least current data of the patient information via a single page record.

2. The method of claim 1, wherein step a) further comprises storing data types of patient information additionally comprising at least one of: hematology laboratory data; chemistry laboratory data; radiology report data; pathology report data; ambulation status; additional patient history, and microbiology data including patient sensitivities.

3. The method of claim 1, wherein the wound data record is stored in a wound electronic medical records system (“WEMRS”), step b) further comprising retrieving and presenting the current data according to a predetermined template based on at least one of a role associated with a medical services provider reviewing the current data and a group type associated with at least one of the medical services provider and a medical services unit.

4. The method of claim 3, further comprising automatically prompting a further medical services provider to input patient information according to a predetermined treatment protocol for a first wound type associated with a wound being treated.

5. The method of claim 4, wherein the predetermined treatment protocol comprises plural ones of the group consisting of: skin regions to be examined, wound dimensions, a wound image, pressure relief, drainage and cellulitis elimination steps, debridement steps, biological treatments comprising growth factor and cellular therapies, nutritional supplementation, physical therapy, and pain elimination.

6. The method of claim 3, further comprising:
c) the medical services provider modifying the predetermined template by modifying a field associated with a type of patient information.

7. The method of claim 4, wherein in step c) the template is determined in part based on a predetermined treatment protocol for a first wound type associated with a wound being treated and the group type, and further comprises modifying the treatment protocol.

8. The method of claim 3, further comprising: reviewing a plurality of wound data records retrieved from at least one WEMRS for at least one of:
treatment review of a first wound by retrieving and comparing wound data records of other patients having a same wound type with said wound data record, protocol validation by retrieving and comparing selected portions of wound data records of patients having at least one of a selected protocol and a selected wound type, and medical research relating to wounds by retrieving and comparing selected portions of wound data records.

9. The method of claim 1, further comprising presenting the current data and prompting the medical services provider for an action associated with selection of a predetermined review indicator for the single page record reviewed by the medical services provider, and automatically generating a billing record based on the single page record reviewed and the review indicator.

10. The method of claim 1, wherein at least some of the data types are presented using color coding for data outside a predetermined nominal limit to alert the medical services provider.

11. A wound data record stored in an wound electronic medical records system (“WEMRS”), comprising:
a) electronically stored patient information comprising: a wound picture, a wound healing rate graph, a wound treatment descriptor, a medication descriptor, a patient identifier, and a review indicator; and
b) plural review record s, each presenting data of the patient information as reviewed by a medical services provider on a recorded date, wherein the review indicator indicates review of the data by the medical services provider.

12. The record of claim 11, wherein each of the plural review records are single page records stored electronically as part of the WEMRS.

13. The record of claim 11, wherein the patient information further comprises at least one of: hematology and chemistry laboratory data; radiology and pathology reports; ambulation status; additional patient history, and microbiology data including patient sensitivities.

14. The record of claim 11, further comprising a template automatically selected based on at least one of a wound type, a role associated with a medical services provider reviewing the current data and a group type associated with at least one of the medical services provider and a medical services unit, wherein the template determines the patient information stored in the wound data record and data presented in at least one of the plural review records.

15. The record of claim 14, further comprising an automatic entry prompt for prompting a further medical services provider to input patient information according to a predetermined treatment protocol for a first wound type associated with a wound being treated.

16. The record of claim 15, wherein the template is determined in part based on a predetermined treatment protocol for a first wound type associated with a wound being treated and the group type.

17. The record of claim 16, wherein at least some of the patient information is color coded indicative of data outside a predetermined nominal limit to alert the medical services provider.

18. A wound electronic medical records system, comprising:
an electronic data store,
plural user devices for data input and review operatively coupled to the electronic data store, and
record instructions operable for:
a) storing, in a wound data record, patient information comprising: a wound picture, a wound healing rate graph, a wound treatment descriptor, a medication descriptor, a patient identifier, and a review indicator; and
b) retrieving and presenting at least current data of the patient information via a single page record on a first user device.

19. The system of claim 18, wherein the record instructions are further operable for storing additional patient information comprising at least one of: hematology and chemistry laboratory data; radiology and pathology reports; ambulation status; additional patient history, and microbiology data including patient sensitivities.

20. The system of claim 18, wherein the record instructions are further operable for:
storing the wound data record in an wound electronic medical records system (“WEMRS”), and
retrieving and presenting the current data according to a predetermined template based on at least one of a role associated with a medical services provider reviewing the current data and a group type associated with at least one of the medical services provider and a medical services unit.

21. The system of claim 20, wherein the record instructions are further operable for automatically prompting a further medical services provider to input updated patient information according to a predetermined treatment protocol for a first wound type associated with a wound being treated.

22. The system of claim 21, wherein the record instructions are further operable for selecting a predetermined treatment protocol based on plural ones of the group consisting of: skin regions to be examined, wound dimensions, a wound image, pressure relief, drainage and cellulitis elimination steps, debridement steps, biological treatments comprising growth factor and cellular therapies, nutritional supplementation, physical therapy, and pain elimination.

23. The system of claim 20, wherein the record instructions are further operable, based on input from the medical services provider, for modifying the predetermined template by modifying a field associated with a type of patient information.

24. The system of claim 21, wherein the template is determined in part based on a predetermined treatment protocol for a first wound type associated with a wound being treated and the group type, and wherein the record instructions are further operable for modifying the treatment protocol.

25. The system of claim 20, wherein the record instructions are further operable for presentation via at least one user device plural wound data records retrieved from at least one WEMRS for at least one of the group consisting of: treatment review of a first wound by retrieving and comparing wound data records of other patients having a same wound type with said wound data record, protocol validation by retrieving and comparing selected portions of wound data records of patients having at least one of a selected protocol and a selected wound type, and medical research relating to wounds by retrieving and comparing selected portions of wound data records.

26. The system of claim 18, wherein the record instructions are further operable for presenting the current data and prompting the medical services provider for an action associated with selection of a predetermined review indicator for the single page record reviewed by the medical services provider, and automatically generating a billing record based on the single page record reviewed and the review indicator.

27. The system of claim 18, wherein the record instructions are further operable for presenting at least some of the data types via color coding for data outside a predetermined nominal limit whereby an alert is output to the medical services provider.

28. A method for wound management using a wound data record stored in an wound electronic medical records system (“WEMRS”), comprising:
a) storing patient information in a wound data record, the patient information comprising plural of the following data types: a wound picture, a wound healing rate graph, a wound treatment descriptor, a medication descriptor, a patient identifier, a review indicator, hematology laboratory data; chemistry laboratory data; radiology report data; pathology report data; ambulation status; additional patient history, and microbiology data including patient sensitivities;
b) in response to a first medical services provider input, displaying an automatic entry prompt for prompting the first medical services provider to input contemporaneous patient information according to a predetermined treatment protocol for a first wound type associated with a wound being treated, the contemporaneous patient information consisting of information about plural of the group of: wound dimensions, undermining, cellulitis, exudate, pain, ulcer location and size, ulcer assessment, and treatment; and
c) retrieving data comprising at least current data of the patient information including part of the contemporaneous patient information input by the first medical services provider, and presenting said retrieved data to a further medical services provider via a single page display record
